(19) United States
(12) Patent Application Publication
(10) Pub. No.: US 2024/0425043 A1
(43) Pub. Date: Dec. 26, 2024

(54) VEHICLE AND METHOD OF CONTROLLING DRIVING THEREOF

(71) Applicants: Hyundia Motor Company, Seoul (KR); Kia Corporation, Seoul (KR)

(72) Inventor: Hyung Jun Lim, Seojong-myeon (KR)

(21) Appl. No.: 18/509,581

(22) Filed: Nov. 15, 2023

(30) Foreign Application Priority Data
Jun. 22, 2023 (KR) 10-2023-0080322

(51) Int. Cl. B60W 30/095; B60Q 9/00; G08G 1/16

(52) U.S. Cl. CPC B60W 30/0956; B60Q 9/008; G08G 1/16

(57) ABSTRACT

In an embodiment, a vehicle includes sensors configured to generate sensor information by sensing the surroundings of the vehicle and an electronic control unit (ECU) configured to execute code. The code can have instructions for the ECU to generate a warning area and a first path trajectory of the vehicle using the sensor information when the vehicle is driven backward, detect a target vehicle located around the generated warning area, generate a target area and a second path trajectory of the target vehicle when the target vehicle is detected, extract a first overlapping area between the target area and the warning area and a second overlapping area between the first path trajectory and the second path trajectory, and perform control whether to issue a rear cross collision warning depending on changes in the first overlapping area and the second overlapping area.

### CROSS-REFERENCE TO RELATED APPLICATIONS

This application claims the benefit of Korean Patent Application No. 10-2023-0080322, filed on Jun. 22, 2023, which application is hereby incorporated herein by reference.

### TECHNICAL FIELD

The present disclosure relates to a vehicle and a method of controlling driving thereof.

### BACKGROUND

Recently developed vehicles are intelligent vehicles equipped with radar sensors, camera sensors, etc., to ensure safety of drivers and vehicles.

For example, a rear detection sensor mounted in a vehicle detects an object present in a rear blind spot of the vehicle using ultrasonic waves during reverse travel of the vehicle, and when an object is detected, a driver is audibly or visually alerted to the risk of collision through, for example, turning on of a warning lamp.

Meanwhile, during travel of a vehicle, a collision avoidance system detects the presence of an obstacle using a distance measurement sensor such as a radar sensor, measures a distance between the vehicle and the obstacle, and alerts a driver.

A recently developed collision avoidance system measures a distance to an obstacle present ahead of or behind a vehicle using a front or rear camera during travel of the vehicle, and displays an image captured by the camera on a monitor.

Such a system enables a driver to more clearly recognize a situation ahead of or behind a vehicle by displaying an image about the situation.

In particular, such a collision warning system is more useful during reverse travel of a vehicle because it is not easy for a driver to recognize a situation behind a vehicle.

The above conventional collision avoidance system calculates a distance to an obstacle and a speed of the obstacle, and sets a collision determination range based on the calculated distance and speed. However, since the collision determination range is relatively wide, unnecessary warnings and controls are frequently performed, thus interfering with safe driving.

### SUMMARY

The present disclosure relates to a vehicle and a method of controlling driving thereof, and more particularly, to a vehicle and a method of controlling driving thereof capable of preventing rear collision of a vehicle during reverse parking or unparking of the vehicle.

Accordingly, embodiments of the present disclosure are directed to a vehicle and a method of controlling driving thereof that substantially obviate one or more problems due to limitations and disadvantages of the related art.

An embodiment of the present disclosure provides a vehicle and a method of controlling driving thereof capable of more specifically determining the risk of collision to support avoidance of collision with an obstacle approaching the rear side of a vehicle during reverse unparking or parking of the vehicle using a sensor, thereby reducing unnecessary warnings and ensuring safe reverse unparking or parking of the vehicle.

However, advantages accomplished by embodiments of the present disclosure are not necessarily limited to the above-mentioned advantages, and other advantages not mentioned herein can be clearly understood by those skilled in the art from the following description.

Additional advantages and features of the disclosure will be set forth in part in the description which follows and in part can become apparent to those having ordinary skill in the art upon examination of the following or may be learned from practice of the disclosure. Other advantages of the disclosure may be realized and attained by the structure and embodiments particularly pointed out in the written description and claims hereof as well as the appended drawings.

To achieve these advantages, and other advantages, and in accordance with embodiments of the disclosure, as embodied and broadly described herein, a method embodiment of controlling driving of a vehicle including an electronic control unit (ECU) includes generating, by the ECU, a warning area and a first path trajectory of the vehicle using sensor information when the vehicle is driven backward, detecting a target vehicle located in or around the generated warning area, generating, by the ECU, a target area and a second path trajectory of the target vehicle when the target vehicle is detected, extracting, by the ECU, a first overlapping area in which the target area and the warning area overlap each other and a second overlapping area in which the first path trajectory and the second path trajectory overlap each other, and determining, by the ECU, whether to issue a rear cross collision warning is selected depending on changes in the first overlapping area and the second overlapping area.

In addition, a method of an embodiment may include, under the control of the ECU, tracking a change in position of the target area within the warning area using at least one of intersection data of the first overlapping area, X-Y position data of the first overlapping area, or position data of a vertex of the target area.

In addition, a method of an embodiment may include, under the control of the ECU, calculating shapes of the first overlapping area and the second overlapping area and calculating intersections of the second overlapping area when the size or area of the calculated shape of the second overlapping area gradually increases as the size or area of the calculated shape of the first overlapping area gradually increases.

In addition, a method of an embodiment may include, under the control of the ECU, determining that the rear cross collision warning is not issued when the size or area of the calculated shape of the first overlapping area gradually decreases.

In addition, a method of an embodiment may include, under the control of the ECU, determining that the rear cross collision warning is not issued when the size or area of the calculated shape of the second overlapping area gradually decreases as the size or area of the calculated shape of the first overlapping area gradually increases.

In addition, a method of an embodiment may include, under the control of the ECU, calculating a first time to intersect taken for the vehicle to reach an intersection located closest to the vehicle among the calculated intersections of the second overlapping area.

In addition, a method of an embodiment may include, under the control of the ECU, calculating a second time to intersect taken for the target vehicle to reach an intersection located closest to the target vehicle among the calculated intersections of the second overlapping area.

In addition, a method of an embodiment may include, under the control of the ECU, determining that the rear cross collision warning is not issued when the first time to intersect is not within a predetermined intersect time range.

In addition, a method of an embodiment may include, under the control of the ECU, determining that the rear cross collision warning is not issued when the first time to intersect is within the predetermined intersect time range and the second time to intersect is not within the predetermined intersect time range.

In addition, a method of an embodiment may include, under the control of the ECU, determining that the rear cross collision warning is issued when the first time to intersect is within the predetermined intersect time range and the second time to intersect is within the predetermined intersect time range.

In an embodiment of the present disclosure, a vehicle includes a plurality of sensors configured to generate sensor information while sensing the surroundings of the vehicle and an electronic control unit (ECU) configured to receive the sensor information from the plurality of sensors to control driving of the vehicle, and the ECU generates a warning area and a first path trajectory of the vehicle using the sensor information when the vehicle is driven backward, detects a target vehicle located in or around the generated warning area, generates a target area and a second path trajectory of the target vehicle when the target vehicle is detected, extracts a first overlapping area in which the target area and the warning area overlap each other and a second overlapping area in which the first path trajectory and the second path trajectory overlap each other, and determines whether to issue a rear cross collision warning depending on changes in the first overlapping area and the second overlapping area.

In addition, an ECU of an embodiment may track a change in position of the target area within the warning area using at least one of intersection data of the first overlapping area, X-Y position data of the first overlapping area, or position data of a vertex of the target area.

In addition, an ECU of an embodiment may calculate shapes of the first overlapping area and the second overlapping area, and may calculate intersections of the second overlapping area when the size or area of the calculated shape of the second overlapping area gradually increases as the size or area of the calculated shape of the first overlapping area gradually increases.

In addition, an ECU of an embodiment may determine that the rear cross collision warning is not issued when the size or area of the calculated shape of the first overlapping area gradually decreases.

In addition, an ECU of an embodiment may determine that the rear cross collision warning is not issued when the size or area of the calculated shape of the second overlapping area gradually decreases as the size or area of the calculated shape of the first overlapping area gradually increases.

In addition, an ECU of an embodiment may calculate a first time to intersect taken for the vehicle to reach an intersection located closest to the vehicle among the calculated intersections of the second overlapping area.

In addition, an ECU of an embodiment may calculate a second time to intersect taken for the target vehicle to reach an intersection located closest to the target vehicle among the calculated intersections of the second overlapping area.

In addition, an ECU of an embodiment may determine that the rear cross collision warning is not issued when the first time to intersect is not within a predetermined intersect time range.

In addition, an ECU of an embodiment may determine that the rear cross collision warning is not issued when the first time to intersect is within the predetermined intersect time range and the second time to intersect is not within the predetermined intersect time range.

In addition, an ECU of an embodiment may determine that the rear cross collision warning is issued when the first time to intersect is within the predetermined intersect time range and the second time to intersect is within the predetermined intersect time range.

It is to be understood that both the foregoing general description and the following detailed description of embodiments of the present disclosure are examples and explanatory, and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain principles of the disclosure. In the drawings:

FIG. 1 is a block diagram for explaining a vehicle according to an embodiment of the present disclosure;

FIG. 2 is a flowchart for explaining a method of controlling driving of a vehicle according to an embodiment of the present disclosure; and

FIGS. 3 to 5 are diagrams for explaining the embodiment shown in FIG. 2.

### DETAILED DESCRIPTION OF ILLUSTRATIVE EMBODIMENTS

Hereinafter, an apparatus and various methods, to which embodiments of the present disclosure can be applied, will be described in more detail with reference to the accompanying drawings. The suffixes “module” and “unit” used herein can describe components assigned or used only in consideration of convenience in creating this specification, and the two suffixes themselves do not necessarily have any distinguishable meanings or roles.

In the following description of the present disclosure, a detailed description of known functions and configurations incorporated herein can be omitted when it may obscure the subject matter of the present disclosure.

An embodiment of the present disclosure largely includes first to third processes. The first process can be a process of collecting information about the surroundings of a vehicle using a sensor mounted in the vehicle. The second process can be a process of calculating, using the information about the surroundings of the vehicle, an overlapping area between a warning area of the vehicle and a target area of a target vehicle and an overlapping area between an expected path trajectory of the vehicle and an expected path trajectory of the target vehicle. The third process can be a process of specifically determining the risk of collision based on the calculated overlapping areas to reduce unnecessary warnings and avoid collision with the target vehicle.

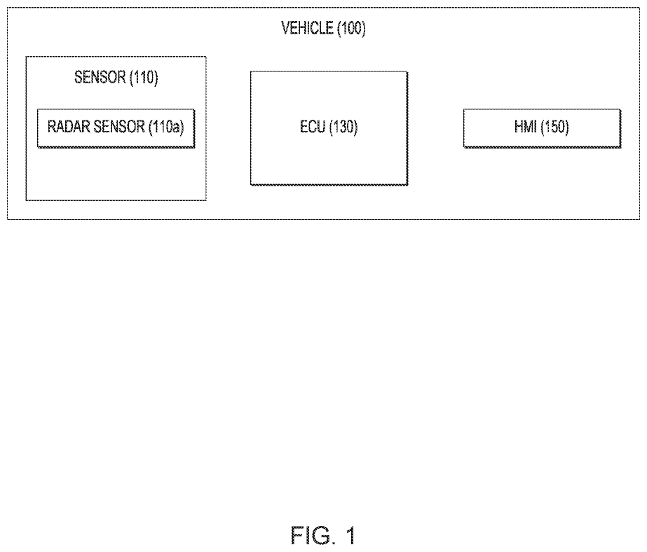

FIG. 1 is a block diagram for explaining a vehicle according to an embodiment of the present disclosure.

Referring to FIG. 1, a vehicle 100 according to an embodiment of the present disclosure may include at least one sensor 110, an electronic control unit (ECU) 130, and a human-machine interface (HMI) 150.

The at least one sensor 110 may generate sensor information while sensing the surroundings of the vehicle 100 in real time. For example, the at least one sensor 110 may include a radar sensor 110a. However, the disclosure is not necessarily limited thereto, and the at least one sensor 110 may include an internal sensor 110 of the vehicle 100, an external sensor 110 of the vehicle 100, or combinations thereof. For example, an internal sensor 110 of the vehicle 100 may sense a vehicle speed, a gear, or the like, and an external sensor 110 of the vehicle 100 may sense a target around the vehicle 100 or the like.

For example, the vehicle 100 may be equipped with a plurality of radar sensors 110a. For example, the radar sensor 110a may be included in a parking assistance system (PAS) that notifies a driver of a distance to an obstacle when the vehicle is parked or driven backward.

The radar sensor 110a may transmit a preset, selected, or predetermined radio wave to a detection range and may individually measure and detect waveforms of reflected radio waves, thereby measuring a distance to an obstacle or a target vehicle and a speed and moving direction of the obstacle or the target vehicle. For example, the radar sensor 110b may be a rear detection radar or a rear-side radar of a rear cross traffic alert (RCTA) system that detects an obstacle approaching the side of the vehicle 100 when the vehicle 100 is driven backward.

Therefore, in an embodiment of the present disclosure, information about the surroundings of the vehicle 100 and an obstacle or target vehicle around the vehicle 100 may be collected by gathering one or more pieces of sensor information detected by at least one radar sensor 110a.

For example, the ECU 130 may receive sensor information from the at least one sensor 110 (e.g., the radar sensor 110a), and may collect information about the surroundings of the vehicle 100 and an obstacle or target vehicle around the vehicle 100.

The ECU 130 can perform filtering using, for example, a Kalman filter, in preparation for occurrence of an error in the sensor information detected by the radar sensor 110a.

In addition, the ECU 130 may generate a warning area and a first path trajectory of the vehicle 100 using the sensor information when the vehicle 100 is driven backward, and may detect a target vehicle located around the generated warning area.

Upon detecting a target vehicle located around the generated warning area, the ECU 130 may generate a target area and a second path trajectory of the target vehicle.

For example, the ECU 130 may generate a warning area of the vehicle 100 and a first path trajectory of the vehicle 100 based on the collected information about the surroundings of the vehicle 100 and an obstacle or target vehicle around the vehicle 100. For example, the ECU 130 may select or generate a warning area of the vehicle 100 in consideration of the collected information about the surroundings of the vehicle 100, an obstacle around the vehicle 100, a width of the vehicle 100, a reverse speed of the vehicle 100, and the like.

The ECU 130 may generate a first path trajectory of the vehicle 100 using the collected information about the surroundings of the vehicle 100, an obstacle around the vehicle 100, and a steering angle of the vehicle 100.

In addition, the ECU 130 may generate a target area of a target vehicle based on the collected information about the surroundings of the vehicle 100 and an obstacle or target vehicle around the vehicle 100. In addition, the ECU 130 may calculate a travel speed or travel direction of the target vehicle using the collected information about the surroundings of the vehicle 100 and an obstacle or target vehicle around the vehicle 100, and may generate a second path trajectory of the target vehicle based on the calculated travel speed or travel direction of the target vehicle.

The ECU 130 may extract a first overlapping area in which the target area and the warning area overlap each other. That is, the ECU 130 may calculate an intersection between the target area and the warning area. The ECU 130 may calculate a width of the target vehicle, and may extract, based on the calculated width of the target vehicle, a first overlapping area in which the target area and the warning area overlap each other.

For example, the ECU 130 may track a change in the position of the target area within the warning area using one of or any combination of intersection data of the first overlapping area, X-Y position data of the first overlapping area, and position data of a vertex of the target area.

In addition, the ECU 130 may extract a second overlapping area in which the first path trajectory and the second path trajectory overlap each other. In this case, it may be assumed that the first path trajectory and the second path trajectory are straight lines. Even when the vehicle 100 and the target vehicle make a turning movement (cornering), the vehicle 100 and the target vehicle may be considered to be moving straight within an expected collision area therebetween.

The ECU 130 may calculate an intersection between the vehicle 100 and the target vehicle, which move straight, through an algorithm for calculation of an intersection between two straight lines meeting at one point.

For example, when the position of the vehicle 100 is defined as (X1, Y1) and the position of the target vehicle is defined as (X2, Y2), the intersection may be calculated through the equation of (Y−Y1)/(X−X1)=(Y2−Y1)/(X2−X1).

After calculating the intersection as the second overlapping area, the ECU 130 may calculate a first time to intersect (TTI) from the current position of the vehicle 100 to the intersection. After calculating the intersection as the second overlapping area, the ECU 130 may calculate a second time to intersect (TTI) from the current position of the target vehicle to the intersection.

In addition, the ECU 130 may perform control such that whether to issue a rear cross collision warning is selected depending on changes in the first overlapping area and the second overlapping area.

For example, the ECU 130 may track a change in the position of the second overlapping area using one of or any combination of intersection data of the second overlapping area, X-Y position data of the second overlapping area, and position data of a vertex of the target area.

As described above, the ECU 130 may specifically determine warning or control for avoidance of rear cross collision by tracking changes in the position of the first overlapping area and the second overlapping area. For example, the ECU 130 may specifically determine warning or control for avoidance of rear cross collision by checking the change in the size (or rate of change) or the change in the position of the first overlapping area or the second overlapping area.

For example, the ECU 130 may calculate shapes of the first overlapping area and the second overlapping area. When the size or area of the calculated shape of the second overlapping area gradually increases as the size or area of the calculated shape of the first overlapping area gradually increases, the ECU 130 may calculate intersections of the second overlapping area.

In addition, when the size or area of the calculated shape of the second overlapping area gradually decreases as the size or area of the calculated shape of the first overlapping area gradually increases, the ECU 130 may perform control such that the rear cross collision warning is not selected.

On the other hand, when the size or area of the calculated shape of the first overlapping area gradually decreases, the ECU 130 may perform control such that the rear cross collision warning is not selected.

The ECU 130 may calculate a first time to intersect (TTI) taken for the vehicle 100 to reach the intersection located closest to the vehicle 100 among the calculated intersections of the second overlapping area.

The ECU 130 may calculate a second time to intersect (TTI) taken for the target vehicle to reach the intersection located closest to the target vehicle among the calculated intersections of the second overlapping area.

Here, the term “time to intersect (TTI)” may be alternatively expressed as a “time to collision (TTC)”. The time to intersect (TTI) may be defined as a time taken for the vehicle 100 to collide with the target vehicle when the speed of the vehicle 100 is constant. The ECU 130 may calculate the time to intersect using information about the travel speed of the vehicle 100 and information about the distance to the intersection.

In this case, when the calculated first time to intersect is not within a preset, selected, or predetermined intersect time range, the ECU 130 may perform control such that the rear cross collision warning is not selected.

When the calculated first time to intersect is within the preset, selected, or predetermined intersect time range and the calculated second time to intersect is not within the preset, selected, or predetermined intersect time range, the ECU 130 may perform control such that the rear cross collision warning is not selected.

On the other hand, when the calculated first time to intersect is within the preset, selected, or predetermined intersect time range and the calculated second time to intersect is within the preset, selected, or predetermined intersect time range, the ECU 130 may perform control such that the rear cross collision warning is selected.

As described above, the vehicle 100 of an embodiment of the present disclosure more specifically determines, under the control of the ECU 130, the risk of collision to support avoidance of collision with an obstacle approaching the rear side of the vehicle during reverse unparking or parking of the vehicle using the sensor 110, thereby reducing unnecessary warnings and ensuring safe reverse unparking or parking of the vehicle.

The ECU 130 may provide information related to rear cross collision warning, etc. to the driver through the HMI 150. For example, the HMI 150 may ensure convenience and safety of the driver by displaying messages, such as information about the vehicle 100, necessity of inspection, and warnings, on the instrument panel of the vehicle 100. The HMI 150 may support a multi-mode feedback function that enables the driver to operate various systems provided in the center fascia of the vehicle 100 using his/her tactile and visual senses. However, the disclosure is not necessarily limited thereto.

The ECU 130 described above may include an electronic stability control (ESC) system to control driving of the vehicle 100. For example, the ESC system may compare operation of a steering wheel by the driver and the rotation state of the vehicle 100, and may stabilize the movement of the vehicle 100 by individually controlling a brake of each wheel. The ESC system generally controls rotation of a wheel using a brake. Alternatively, depending on a system, driving torque of an engine may be controlled to lower engine output.

The ECU 130 may control braking and driving of the vehicle to avoid collision with the target vehicle that is traveling.

In addition, the ECU 130 may not only control deceleration of the vehicle 100 through at least one of a braking device of the vehicle 100 or a driving device of the vehicle 100, but may also alert the driver through the HMI 150.

In addition, the ECU 130 may alert the driver by issuing a warning indicating that a target vehicle or an obstacle is approaching the vehicle through the HMI 150.

The components described above with reference to FIG. 1 are example components of an embodiment. In practice, the vehicle 100 may include more or fewer components than those shown in FIG. 1.

The radar sensor 110a, the ECU 130, and the HMI 150 shown in FIG. 1 may transmit and receive information to and from each other through vehicle communication (e.g., CAN communication, LIN communication, or hard wire communication). However, embodiments of the disclosure is not necessarily limited thereto.

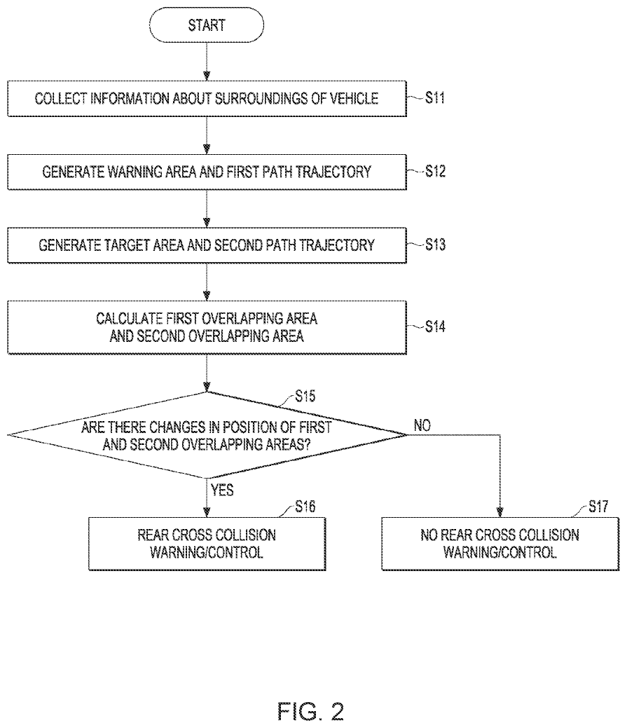

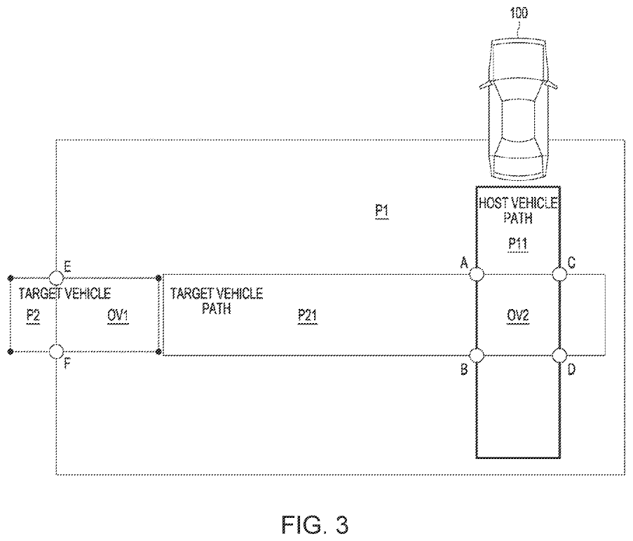

FIG. 2 is a flowchart for explaining a method of controlling driving of a vehicle according to an embodiment of the present disclosure. FIGS. 3 to 5 are diagrams for explaining the embodiment shown in FIG. 2.

Referring to FIGS. 2 to 5, in an embodiment of the present disclosure, information about the surroundings of the vehicle 100 and an obstacle or target vehicle around the vehicle 100 may be collected by fusing or gathering one or more pieces of sensor information detected by at least one radar sensor 110a (operation S11).

For example, the ECU 130 may receive sensor information from the at least one sensor 110 (e.g., the radar sensor 110a), and may collect information about the surroundings of the vehicle 100 and an obstacle or target vehicle around the vehicle 100.

In addition, the ECU 130 may generate a warning area P1 and a first path trajectory P11 of the vehicle 100 using the sensor information when the vehicle 100 is driven backward, and may detect a target vehicle located around the generated warning area P1 (operation S12).

The ECU 130 may select or generate the warning area P1 of the vehicle 100 in consideration of the collected information about the surroundings of the vehicle 100, an obstacle around the vehicle 100, a width of the vehicle 100, a reverse speed of the vehicle 100, and the like.

The ECU 130 may generate the first path trajectory P11 of the vehicle 100 using the collected information about the surroundings of the vehicle 100, an obstacle around the vehicle 100, and a steering angle of the vehicle 100.

Upon detecting a target vehicle located around the generated warning area P1, the ECU 130 may generate a target area P2 and a second path trajectory P21 of the target vehicle (operation S13).

For example, the ECU 130 may generate the target area P2 of the target vehicle based on the collected information about the surroundings of the vehicle 100 and an obstacle or target vehicle around the vehicle 100. In addition, the ECU 130 may calculate a travel speed and/or travel direction of the target vehicle using the collected information about the surroundings of the vehicle 100 and an obstacle or target vehicle around the vehicle 100, and may generate the second path trajectory P21 of the target vehicle based on the calculated travel speed and/or travel direction of the target vehicle.

The ECU 130 may extract a first overlapping area OV1 in which the target area P2 and the warning area P1 overlap each other and a second overlapping area OV2 in which the first path trajectory and the second path trajectory overlap each other (operation S14).

The ECU 130 may calculate an intersection between the target area P2 and the warning area P1. The ECU 130 may calculate a width of the target vehicle, and may extract, based on the calculated width of the target vehicle, the first overlapping area OV1 in which the target area P2 and the warning area P1 overlap each other.

The ECU 130 may extract the second overlapping area OV2 in which the first path trajectory P11 and the second path trajectory P21 overlap each other. In this case, it may be assumed that the first path trajectory P11 and the second path trajectory P21 are straight lines. Even when the vehicle 100 and the target vehicle make a turning movement (cornering), the vehicle 100 and the target vehicle may be considered to be moving straight within an expected collision area therebetween.

The ECU 130 may calculate an intersection between the vehicle 100 and the target vehicle, which move straight, through an algorithm for calculation of an intersection between two straight lines meeting at one point. Since the process of calculating the intersection has been described above in detail, a further description thereof will be omitted.

The ECU 130 may perform control such that whether to issue a rear cross collision warning is selected depending on changes in the position of the first overlapping area OV1 and the second overlapping area OV2 (operation S15).

For example, as shown in FIGS. 3 to 5, the ECU 130 may specifically determine warning or control for avoidance of rear cross collision by tracking changes in the position of the first overlapping area OV1 and the second overlapping area OV2 (operation S15). For example, the ECU 130 may specifically determine warning or control for avoidance of rear cross collision by checking the change in the size (or rate of change) or the change in the position of the first overlapping area OV1 or the second overlapping area OV2 (operations S16 and S17).

For example, as shown in FIG. 3, the ECU 130 may calculate shapes of the first overlapping area OV1 and the second overlapping area OV2. When the size or area of the calculated shape of the second overlapping area OV2 gradually increases as the size or area of the calculated shape of the first overlapping area OV1 gradually increases, the ECU 130 may calculate intersections of the second overlapping area OV2.

As shown in FIG. 3, when the calculated first time to intersect is within a preset, selected, or predetermined intersect time range and the calculated second time to intersect is within the preset, selected, or predetermined intersect time range, the ECU 130 may perform control such that the rear cross collision warning is selected (operation S16).

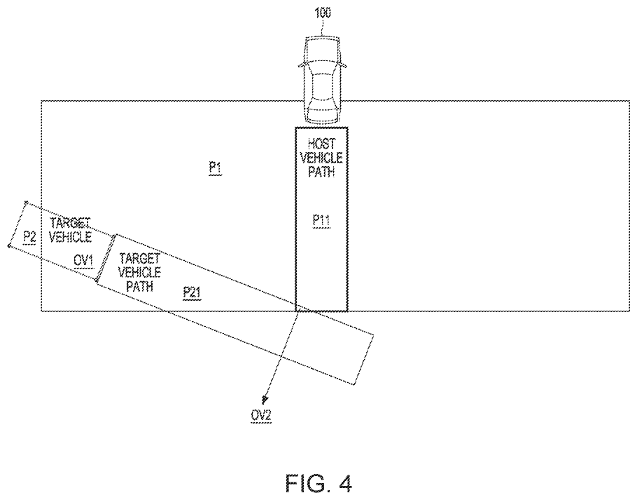

On the other hand, as shown in FIG. 4, when the size or area of the calculated shape of the second overlapping area OV2 gradually decreases as the size or area of the calculated shape of the first overlapping area OV1 gradually increases, the ECU 130 may perform control such that the rear cross collision warning is not selected (operation S17). When the size or area of the calculated shape of the first overlapping area OV1 gradually decreases, the ECU 130 may perform control such that the rear cross collision warning is not selected (operation S17).

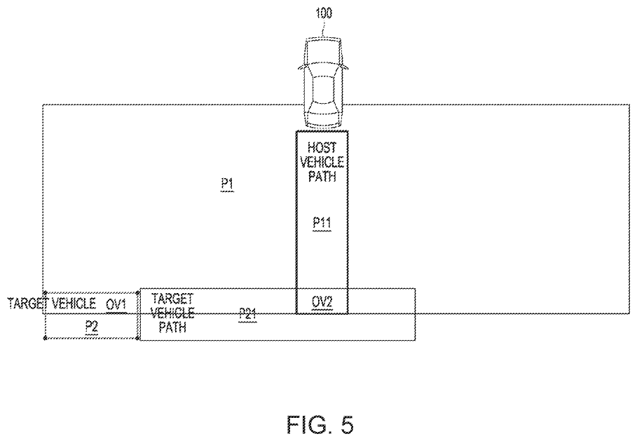

In addition, as shown in FIG. 5, the ECU 130 may calculate shapes of the first overlapping area OV1 and the second overlapping area OV2. When the size or area of the calculated shape of the second overlapping area OV2 gradually increases as the size or area of the calculated shape of the first overlapping area OV1 gradually increases, the ECU 130 may calculate the first time to intersect and the second time to intersect.

The first time to intersect may be defined as a time taken for the vehicle 100 to reach the intersection located closest to the vehicle 100 among the calculated intersections of the second overlapping area OV2. The second time to intersect may be defined as a time taken for the target vehicle to reach the intersection located closest to the target vehicle among the calculated intersections of the second overlapping area OV2.

As shown in FIG. 5, when the calculated first time to intersect is not within the preset, selected, or predetermined intersect time range, the ECU 130 may perform control such that the rear cross collision warning is not selected (operation S17).

When the calculated first time to intersect is within the preset, selected, or predetermined intersect time range and the calculated second time to intersect is not within the preset, selected, or predetermined intersect time range, the ECU 130 may perform control such that the rear cross collision warning is not selected (operation S17).

As described above, the vehicle 100 of an embodiment of the present disclosure can more specifically determine, under the control of the ECU 130, a risk of collision to support avoidance of collision with an obstacle approaching the rear side of the vehicle during reverse unparking or parking of the vehicle using the sensor 110, thereby reducing unnecessary warnings and ensuring safe reverse unparking or parking of the vehicle.

The method according to the above-described embodiment may be implemented as a program to be executed on a computer and may be stored as code in a computer-readable recording medium. Examples of the computer-readable recording medium may include ROM, RAM, CD-ROM, a magnetic tape, a floppy disk, an optical data storage device, or any combination thereof, for example.

The computer-readable recording medium may also be distributed over network-coupled computer systems so that the computer-readable code is stored and executed in a distributed fashion. Also with hindsight of the present disclosure, functional programs, code, and code segments for executing the above-described method may be easily constructed by programmers skilled in the art to which the present disclosure pertains.

As is apparent from the above description, the vehicle and the method of controlling driving thereof according to an embodiment of the present disclosure can have the following effects and advantages, for example.

First, an embodiment of the present disclosure can calculate a first overlapping area between a warning area of the vehicle and a target area of a target vehicle and a second overlapping area between a path trajectory of the vehicle and a path trajectory of the target vehicle, and more specifically can determine a risk of collision based thereon, thereby more precisely determining warning/control, thus minimizing or preventing unnecessary warnings/controls.

Second, an embodiment of the present disclosure can specifically determine a risk of collision, thereby more precisely determining warning/control, thus improving driving stability of the vehicle.

Third, an embodiment of the present disclosure can more precisely determine a risk of collision, thereby improving driving stability of the vehicle, and thus ensuring safety of a driver.

Fourth, because a radar sensor already mounted in the vehicle can be used, an embodiment of the present disclosure may be economical without incurring additional component cost and mounting cost.

However, the effects achievable through an embodiment of the present disclosure are not necessarily limited to the above-mentioned effects and advantages, and other effects and advantages not mentioned herein can be clearly understood by those skilled in the art from the above description.

It can be apparent to those skilled in the art that various changes in form and details may be made without departing from the spirit of the disclosure set forth herein.

The scope of the disclosure should be determined by reasonable interpretation of the appended claims, and all equivalent modifications made without departing from the disclosure should be included in the following claims.

What is claimed is:

1. A method of controlling driving of a vehicle, the method comprising:
generating a warning area and a first path trajectory of the vehicle using sensor information in response to the vehicle being driven backward;
detecting a target vehicle located in or around the generated warning area;
generating a target area and a second path trajectory of the target vehicle in response to the target vehicle being detected;
extracting a first overlapping area in which the target area and the warning area overlap each other;
extracting a second overlapping area in which the first path trajectory and the second path trajectory overlap each other; and
determining whether to issue a rear cross collision warning depending on changes in the first overlapping area and the second overlapping area.

2. The method of claim 1, further comprising tracking a change in position of the target area within the warning area using one of or any combination of intersection data of the first overlapping area, X-Y position data of the first overlapping area, and position data of a vertex of the target area.

3. The method of claim 1, further comprising:
calculating shapes of the first overlapping area and the second overlapping area; and
calculating intersections of the second overlapping area when a size or area of the calculated shape of the second overlapping area gradually increases as a size or area of the calculated shape of the first overlapping area gradually increases.

4. The method of claim 3, further comprising determining that the rear cross collision warning is not issued in response to the size or area of the calculated shape of the first overlapping area gradually decreasing.

5. The method of claim 3, further comprising determining that the rear cross collision warning is not issued in response to the size or area of the calculated shape of the second overlapping area gradually decreasing as the size or area of the calculated shape of the first overlapping area gradually increases.

6. The method of claim 3, further comprising calculating a first time to intersect for the vehicle to reach an intersection located closest to the vehicle among the calculated intersections of the second overlapping area.

7. The method of claim 6, further comprising calculating a second time to intersect for the target vehicle to reach an intersection located closest to the target vehicle among the calculated intersections of the second overlapping area.

8. The method of claim 7, further comprising determining that the rear cross collision warning is not issued in response to the first time to intersect being not within a selected intersect time range.

9. The method of claim 7, further comprising determining that the rear cross collision warning is not issued in response to the first time to intersect being within a first selected intersect time range and the second time to intersect being not within a second selected intersect time range.

10. The method of claim 7, further comprising determining that the rear cross collision warning is issued in response to the first time to intersect being within a first selected intersect time range and the second time to intersect being within a second selected intersect time range.

11. A vehicle comprising:
a sensor configured to generate sensor information by sensing surroundings of the vehicle; and
an electronic control unit (ECU) configured to receive the sensor information from the sensor, and the ECU being configured to execute code, wherein the code comprises instructions for the ECU to:
generate a warning area and a first path trajectory of the vehicle using the sensor information in response to the vehicle being driven backward,
detect a target vehicle located in or around the generated warning area using the sensor information,
generate a target area and a second path trajectory of the target vehicle in response to the target vehicle being detected,
extract a first overlapping area in which the target area and the warning area overlap each other,
extract a second overlapping area in which the first path trajectory and the second path trajectory overlap each other, and
determine whether to issue a rear cross collision warning depending on changes in the first overlapping area and the second overlapping area.

12. The vehicle of claim 11, wherein the code further comprises instructions for the ECU to track a change in position of the target area within the warning area using one of or any combination of intersection data of the first overlapping area, X-Y position data of the first overlapping area, and position data of a vertex of the target area.

13. The vehicle of claim 11, wherein the code further comprises instructions for the ECU to:
calculate shapes of the first overlapping area and the second overlapping area, and
calculate intersections of the second overlapping area in response to a size or area of the calculated shape of the second overlapping area gradually increasing as a size or area of the calculated shape of the first overlapping area gradually increases.

14. The vehicle of claim 13, wherein the code further comprises instructions for the ECU to determine that the rear cross collision warning is not issued in response to the size or area of the calculated shape of the first overlapping area gradually decreasing.

15. The vehicle of claim 13, wherein the code further comprises instructions for the ECU to determine that the rear cross collision warning is not issued in response to the size or area of the calculated shape of the second overlapping area gradually decreasing as the size or area of the calculated shape of the first overlapping area gradually increases.

16. The vehicle of claim 13, wherein the code further comprises instructions for the ECU to calculate a first time to intersect for the vehicle to reach an intersection located closest to the vehicle among the calculated intersections of the second overlapping area.

17. The vehicle of claim 16, wherein the code further comprises instructions for the ECU to calculate a second time to intersect for the target vehicle to reach an intersection located closest to the target vehicle among the calculated intersections of the second overlapping area.

18. The vehicle of claim 17, wherein the code further comprises instructions for the ECU to determine that the rear cross collision warning is not issued in response to the first time to intersect being not within a selected intersect time range.

19. The vehicle of claim 17, wherein the code further comprises instructions for the ECU to determine that the rear cross collision warning is not issued in response to the first time to intersect being within a first selected intersect time range and the second time to intersect being not within a second selected intersect time range.

20. The vehicle of claim 17, wherein the code further comprises instructions for the ECU to determine that the rear cross collision warning is issued in response to the first time to intersect being within a first selected intersect time range and the second time to intersect being within a second selected intersect time range.
